(19) United States
(12) Patent Application Publication
(10) Pub. No.: US 2008/0244740 A1
(43) Pub. Date: Oct. 2, 2008

(54) BROWSER-INDEPENDENT EDITING OF CONTENT

(75) Inventors: Ryan Hicks, Seattle, WA (US); Simon Gershey, Seattle, WA (US); Blake Macurdy, Seattle, WA (US); Alex Berg, Seattle, WA (US); Steve Apel, Seattle, WA (US)

Correspondence Address: PERKINS COIE LLP;PATENT-SEA, P.O. BOX 1247, SEATTLE, WA, 98111-1247, US

(73) Assignee: wetpaint.com, inc., Seattle, WA (US)

(21) Appl. No.: 12/043,718

(22) Filed: Mar. 6, 2008

Related U.S. Application Data
(60) Provisional application No. 60/893,351, filed on Mar. 6, 2007.

(51) Int. Cl. G06F 21/24; G06F 17/00; G06F 17/28

(52) U.S. Cl. 726/22; 715/239; 726/26; 704/2

(57) ABSTRACT

A system for editing a web page includes receiving the web page in a normalized form, where the normalized form is independent of any browser form. The page may be displayed to a user, where the web page has been translated from the normalized form to a browser-dependent form, and editable by the user. The web page may be a Wiki or collaborate web page. Overall, described in detail above is a unified editing system for editing a collaborative web page is described. The collaborative web page having a normalized form that is independent of any browser form. The system displays the collaborative web page that has been translated from the normalized form to a browser-dependent form to a user, wherein the browser-dependent form of the collaborative web page is editable by a user. The unified editing system receives from the user the edited collaborative web page in the browser-dependent form. Other features and aspects of the invention are also disclosed.

### BACKGROUND

Collaborative web pages are becoming more and more common on the Internet. A collaborative web page (sometimes called a wiki) is a website that allows visitors of the website to easily add, remove, and otherwise edit and change available content. Websites containing collaborative web pages may allow for easy linking among any number of pages. This ease of interaction and operation makes a collaborative web page an effective tool for mass collaborative authoring. A collaborative web page enables users to write documents very collaboratively in a simple markup language using a web browser. A defining characteristic of collaborative web page technology is the ease with which users can create and update web pages. Many edits, however, can be made in real-time, and appear almost instantaneously online. Often, there is no review before modifications are accepted. Many collaborative web pages are open to the general public without the need to register any user account. Private collaborative web page servers require user authentication to edit, and sometimes even to read, collaborative web pages and provide greater security and authenticity to the content.

The manner in which users edit content varies among collaborative websites. Simple collaborative web sites allow only basic text formatting, whereas more complex ones have support for tables, images, formulas, or even interactive elements such as polls and games. Many basic collaborative websites consider HyperText Markup Language (HTML) too difficult for inexperienced users to manipulate directly, and therefore only allow users to contribute plain text content to the website. This method severely limits the types of content that users can add to the website. Other intermediate collaborative websites have created a special language that users can use to add formatted content. For example, one convention is to treat an asterisk (“*”) before an item as a user request to add that item to a bulleted list. This method allows users to add more types of content, but requires that the users learn the special language and limits the users to the types of content that the language provides. More advanced collaborative websites allow users to edit HTML directly. Making typical HTML source visible makes the actual text content very hard to read and edit for most users. Allowing users to edit HTML also allows users to potentially add content based on malicious or annoying behavior. For example, a user can add a link that displays one target but actually navigates to another target when it is selected. Allowing users to edit HTML directly also reduces the consistency between collaborative web pages that are part of the same collaborative website.

Some recent wiki engines use a different method: they allow “WYSIWYG” (What You See Is What You Get) editing, usually by means of JavaScript or an ActiveX control that translates graphically entered formatting instructions, such as “bold” and “italics”, into the corresponding HTML tags. In those implementations, the markup of a newly-edited HTML version of the page is generated transparently, and the user is shielded from these technical details. While this method provides the most formatting options to the user with the least difficulty, the resulting HTML frequently varies when interpreted and displayed by different web.

Today's Internet is characterized by different web browsers that allow users to access web sites and display content on their personal computers and digital devices. The result is a “Tower of Babel” of different browsers rendering underlying HTML code for display to the end user. Different browsers often render content differently. For web pages that users can edit, different browsers often produce different HTML for similar concepts. For example, the Firefox web browser typically separates paragraphs of text using the break (<BR>) HTML tag, whereas the Internet Explorer browser typically uses the paragraph (<P>) tag. These differences do not typically cause problems so long as all of the users editing a particular web page are using the same browser. However, once many users begin collaborating on a web page using different browsers, the content can be negatively affected. For example, the different paragraph-separating conventions of Firefox and Internet Explorer lead to an unexpected result when a user attempts to create a bulleted list of a set of paragraphs separated by different tags. Rather than displaying each paragraph as a separate bullet as the user expects, most browsers will only treat paragraphs using one of the tags (e.g., <BR> or <P>) as being part of the bulleted list. The user of the WYSIWYG editor may not understand why the content is not showing up as expected and may not have any means of correcting the error.

There is a need for a system that overcomes the above problems, as well as one that provides additional benefits.

### BRIEF DESCRIPTION OF THE DRAWINGS

FIG. 1 is a block diagram that illustrates the processing of a unified editing system to translate content to and from a normalized format.

FIGS. 2-4 illustrate the display of a web page that a user is editing using three different browsers.

FIG. 5 is a block diagram that illustrates a suitable computing system for a client or server of the unified editing system.

FIG. 6 is a block diagram that illustrates a typical computing environment in which the system operates.

The headings provided herein are for convenience only and do not necessarily affect the scope or meaning of the claimed invention.

### DETAILED DESCRIPTION

### Overview

A method and system for WYSIWYG editing of collaborative web pages using multiple browsers is provided, sometimes referred to below as the unified editing system. The unified editing system stores content in a normalized, or standardized, format that the system can easily modify to support the idiosyncrasies of many web browsers (e.g., Mozilla Firefox, Microsoft Internet Explorer, and Apple Safari). The content may be normalized such that it does not reference any particular browser's format. Typically, the unified editing system stores normalized HTML at a server that provides the normalized HTML to a client upon request. In one embodiment, the unified editing system receives a request from a user to edit a collaborative web page. Upon receiving the editing request, the unified editing system receives normalized HTML comprising the existing content of the collaborative web page (e.g., added by other users) from the server. The unified editing system detects the browser that the user is editing the content from and converts the existing content from its normalized format to the browser's preferred format. Then, the user edits the content in the browser's preferred format. When the user has finished editing the content (e.g., by indicating that the user wants to save the content), the unified editing system receives the edited content in the browser's preferred format. The unified editing system converts the edited content into a normalized format, and then saves the normalized content to the server. Thus, the unified editing system allows multiple users to contribute content to a collaborative website using many different web browsers, while preventing inconsistencies in the format of the content caused by varying behavior of the different web browsers.

As noted above, sometimes the unified editing system stores edited content on a server accessible by many clients. The conversion from the browser-preferred format of one client to the normalized format for storage on the server may be performed in part on the client and in part on the server. For example, client side technologies such as JavaScript, may be used to perform processing such as converting from one paragraph separating convention to another, while server side software components may perform additional processing such as balancing opening and closing HTML tags, and so forth. The description below describes processing techniques typically performed on the client, followed by processing techniques typically performed on the server. Although a particular processing technique is described in the context of the client and the server, those of ordinary skill in the art will recognize that these processing techniques can be divided in many different ways between the client and server. For example, the unified editing system may accept HTML content from a client application that performs no special processing, and the server may perform all of the processing to turn the HTML content into a normalized format.

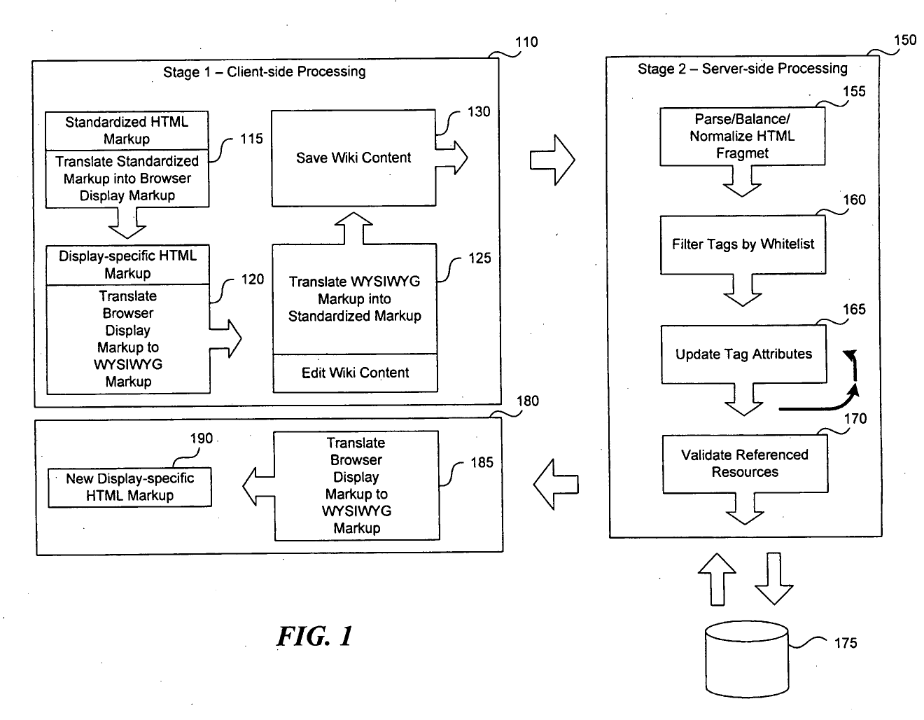

FIG. 1 is a block diagram that illustrates the processing of the unified editing system to translate content to and from a normalized format in one embodiment. The processing performed by the client during editing is illustrated in block 110. In block 115, the client receives existing content in a normalized format from the server and translates the content into the browser-preferred format. In block 120, the client displays the translated content, and upon receiving an editing command from the user, translates the content into a WYSIWYG editable format. In block 125, the client translates any changes made by the user into the normalized format received by the server.

The processing performed by the server is illustrated in block 150. In block 155, the server performs general cleanup on the received content to produce well-structured HTML (e.g., balancing opening and closing tags). In block 160, the server applies a whitelist to remove undesirable tags. In block 165, the server performs tag-specific filtering, such as updating the width and height attributes of an image to stay below a maximum resolution. In block 170, the server validates any resources referenced by the received content. The server then stores the normalized content in a database 175 or other storage device.

The processing performed when a user subsequently makes a request to display the content is illustrated in block 180. In blocks 185 and 190, the client receives the content from the server, translates the content from the normalized format into the browser-preferred format, and displays the content to the user.

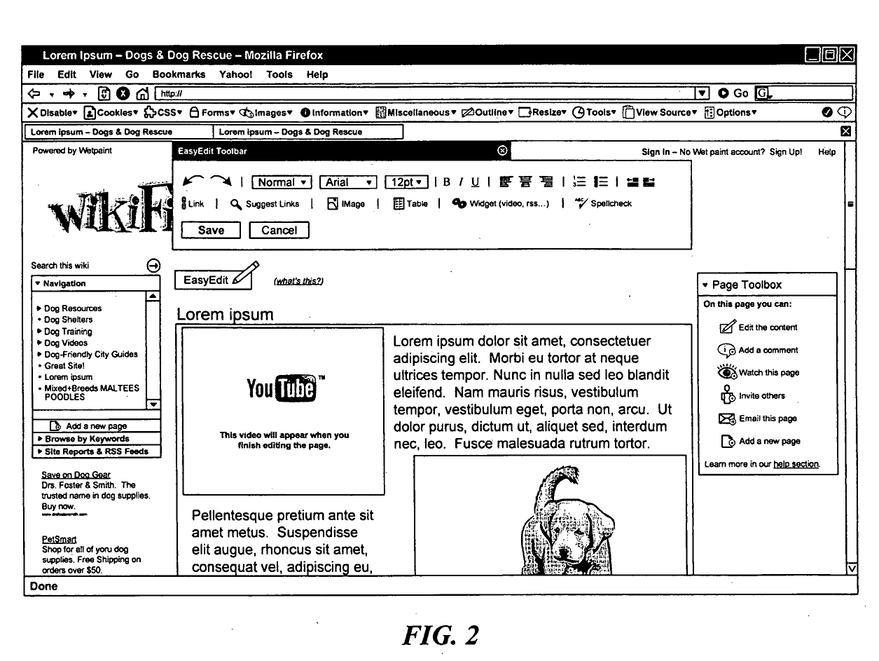

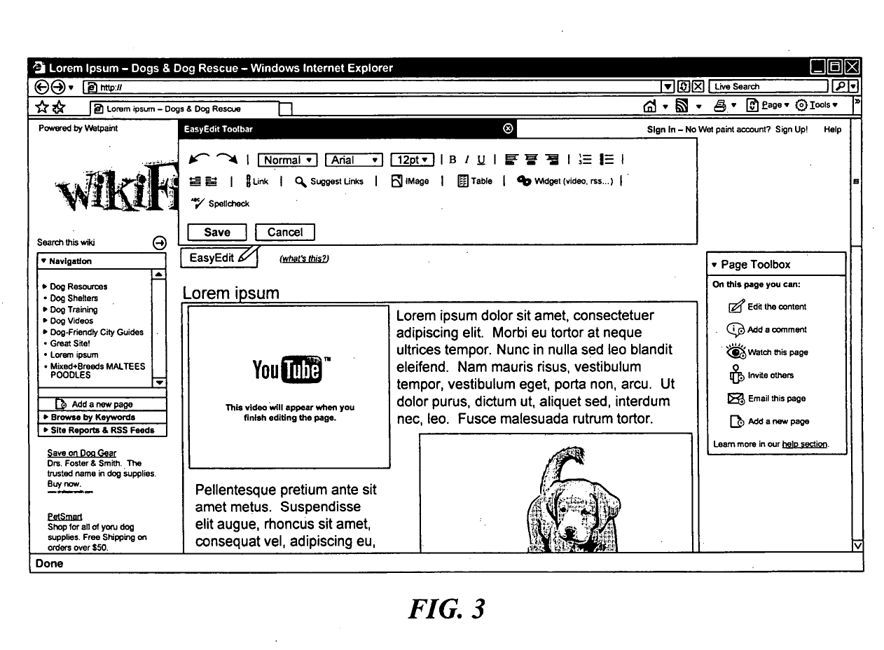

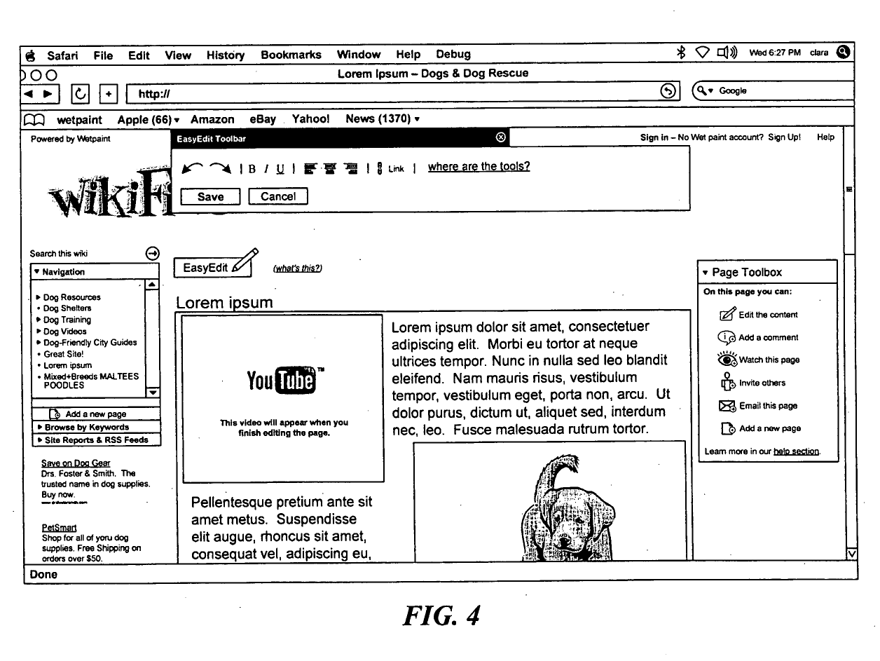

FIGS. 2-4 illustrate the display of a web page that a user is editing using three different browsers. FIG. 2 illustrates how the web page appears using Mozilla Firefox, FIG. 3 illustrates how the web page appears using Microsoft Internet Explorer, and FIG. 4 illustrates how the web page appears using Apple Safari. As the figures show, the web page appears very consistent between each browser, even though each of these browsers handles HTML and other content differently. Translating content from the browser-preferred format of each browser to a normalized format allows the content to be more consistently displayed and edited by each different browser.

Collaborative web page content, HTML content, and other references to content herein can describe many different types of content associated with a collaborative web page. For example, collaborative web page content may include plain text, formatted text, graphics, videos, sound files, YouTube videos, Google Calendars, maps, PhotoBucket slideshows, links to external content hosted on other servers, or any other type of content typically available on the Internet. In some embodiments, the unified editing system provides a design mode for each collaborative web page in which users can edit the web page. For example, each web page may have an “Edit” button that, when selected, causes the web page to switch from a viewing mode to a design mode in which a user can edit the content of the web page. Upon entering the design mode, the unified editing system converts the content of the web page into a form that is easy to edit. For example, the unified editing system may add space after a table to allow a user to select that location for adding new content. The unified editing system may attempt to make the web page look as similar in design mode as it does in the viewing mode. For content that is difficult to edit in place, such as a video, the unified editing system may replace the content with a box or other shape that allows the user to edit the size and location of the content within the web page.

Aspects of the invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented herein is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

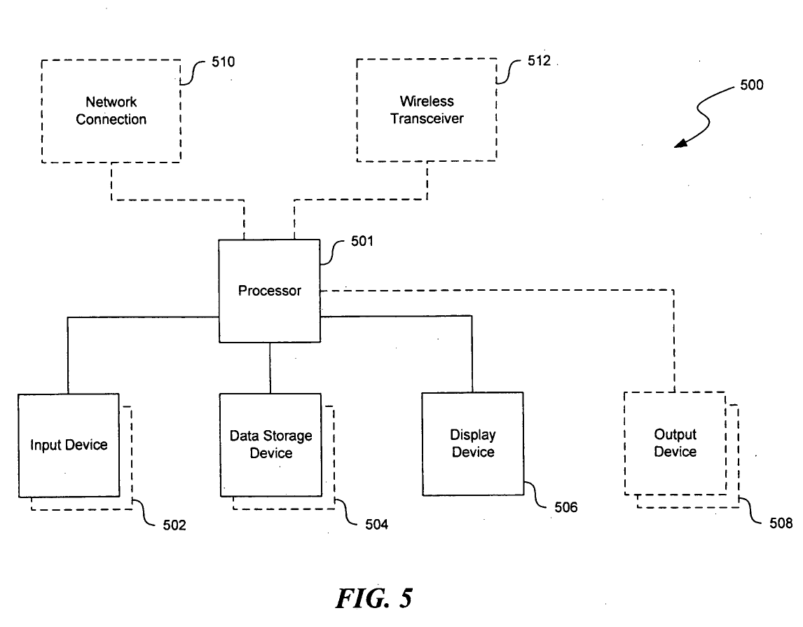

FIG. 5 is a block diagram that illustrates a suitable computing system for a client or server of the unified editing system, in one embodiment. The computing system 500 may include one or more processors 501, one or more input devices 502, one or more data storage devices 504, a display device 506, and one or more output devices 508. The computing system 500 may also include hardware for connecting to other computer systems, such as a network connection 510 and/or wireless transceiver 512. The input devices 502 may include a keyboard, mouse, tablet, microphone, and so forth. The data storage devices 504 may include a hard drive, optical disk drive, USB flash drive, storage area network (SAN), and so forth. The data storage devices 504 may contain computer-readable media encoded with instructions for performing one or more of the methods described herein.

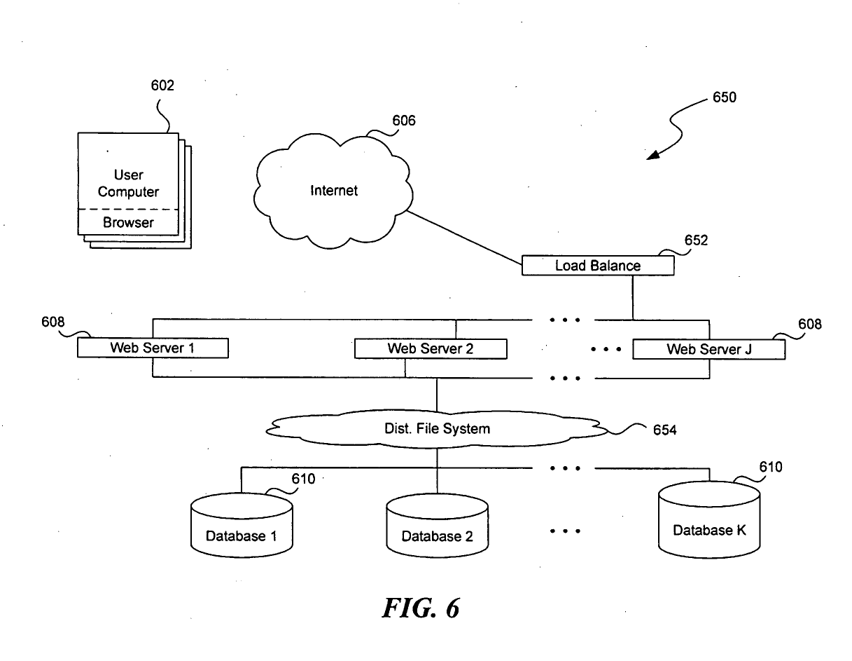

FIG. 6 is a block diagram that illustrates a typical computing environment in which the system operates. A user's computer 602 includes a browser for viewing a web page. The user's computer 602 is connected to a public network such as the Internet 606, through which the user's computer 602 accesses a website 650. The website 650 may include a load balancer 652, one or more web servers 608, a distributed file system 654, and one or more databases 610. The load balancer 652 ensures that user requests are distributed among the various web servers 608. The databases 610 store the web page content offered by the website 650. The web servers 608 access the databases 610 and provide the stored web page content in response to received user requests.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

### Client Processing

As described above, the client receives content from the server in a normalized format preferred by the system for storing content in a browser-neutral manner. The normalized format may simply be one browser's preferred format, which the unified editing system converts into content appropriate for all other browsers, or the normalized format may be independent of any particular browser. The client may use scripting code (such as JavaScript), controls (such as ActiveX controls), or any other client-side mechanism for carrying out instructions to perform the functionality described in this section.

The unified editing system receives a request from a user to edit a collaborative web page. For example, the web page may contain an “EasyEdit” button or other controls that, when selected, indicate a user's intention to edit the web page. Upon receiving the editing request, the unified editing system receives normalized HTML comprising the existing content of the collaborative web page (e.g., added by other users) from the server. If the web page is new, such that other users have not yet added any content, the server may not provide any content for the page. Alternatively, the server may provide one or more templates for creating a new collaborative web page that provide an initial starting set of content for the user to edit.

The unified editing system detects the browser that the user is using to edit the content and converts the existing content from its normalized format to that browser's preferred format. For example, the unified editing system may detect the browser using client-side scripting and an Application Programming Interface (API) provided by the browser. Alternatively, the server may forward the user-agent information (which contains information about the client browser) sent by the client in the request for the collaborative web page back to the client. Converting from the normalized format to the browser's preferred format may include many types of translations and manipulations of HTML. For example, the unified editing system may convert paragraph tags (<P>) to break tags (<BR>), or the unified editing system may ensure that break tags are in a self-terminating form (e.g., <BR/>) that is compatible with a particular browser. As another example, the unified editing system may add space after a table to provide a screen region for the user to select to add new content below the table. Firefox currently does not render tables with any extra space (i.e., not explicitly specified in HTML) below them, making it difficult for a user to select this region to add new content.

In some embodiments, the client may perform additional types of translation of the content from the normalized format to the browser's preferred format. For example, if the client detects that the user's device is a cell phone, then the client may modify the content to improve the display of the content on the small cell phone screen. As another example, if the client detects that the user prefers a different language than the original language in which the content is written, then the unified editing system client may translate the content from the original language to the user's preferred language. Alternatively, or additionally, the server may perform such translations/modifications.

Next, the user edits the content in the browser's preferred format. For example, if the user creates a new paragraph in Internet Explorer, then the browser will add paragraph tags to separate the paragraphs. During conversion to the browser's preferred format, the unified editing system may replace embedded content that is difficult to edit in place, such as a video, with a box or other shape whose size and location the user can edit. Alternatively, the unified editing system may allow the user to edit the content directly within the web page. For example, a user may be able to add additional images to a PhotoBucket slideshow or modify a Google Calendar directly within the web page.

When the user has finished editing the content (e.g., by indicating that the user wants to save the content), the unified editing system receives the edited content in the browser's preferred format. The unified editing system then converts the edited content into a normalized format. For example, the unified editing system may convert paragraph tags added by Internet Explorer into break tags for storing on the server. The client may only be responsible for pre-translating the content, relying on the server to perform more complex translations of the content into a normalized format. For example, the client may convert emphasis tags (<EM>) to bold tags (<B>), while the server may ensure that tags are properly closed. The next section describes additional steps performed by the server in further detail.

### Server Processing

As described above, the server receives content that a user has edited from the client. The client may have performed some pre-translation of the content from a format preferred by the user's browser, and the server performs additional translation of the content to produce content in a normalized format suitable for easy translation to any particular browser's preferred format when the unified editing system receives a new request to edit the content. As described below, the additional translation performed by the server may include comparing the HTML tags within the content with a whitelist of normalized tags, performing tag-specific handling, and sanitizing references to external resources.

In some embodiments, the server of the unified editing system invokes a third-party provided component to convert the content received from the client into well-formed HTML and objects that are more easily manipulated. For example, www.cyberneko.org provides an open-source library that translates badly formed HTML input into well-formed HTML output. Badly formed HTML may include HTML with tags that are not properly closed (e.g., a <P> tag without a subsequent </P> tag), HTML “child” elements that are missing appropriate “parent” elements (e.g., a <TD> tag without a previous <TABLE> tag), and so forth. Badly formed HTML may be the result of, for example, an error in a browser, a difference in the browser's interpretation of the HTML specification, or a user error in user-specified HTML. The third-party component may also parse the HTML content and create programmatic objects that are easier for the server to manipulate than text.

In some embodiments, the unified editing system server compares the tags within the content with a whitelist of acceptable, normalized tags. There are many tags in the HTML specification that the server may not support. For example, the server may prefer a single method of emphasizing text, thus preferring the bold tag (<B>) over other forms of emphasizing text such as the emphasis tag (<EM>), strong tag (<STRONG>), and so forth. Therefore, the server may filter out these other tags and remove them from the content, or the server may convert them to the preferred tag. The client may have added many tags that the unified editing system considers unnecessary for effectively rendering the content. For example, when a user drags a picture from Microsoft Word to a collaborative web page, many extra tags with metadata about the picture are added to the HTML of the web page. These tags may specify information, such as the document from which the user obtained the picture, which are not relevant to the display of the collaborative web page. Thus, the server may remove these tags from the content received from the client.

The whitelist may also contain multiple levels, such that not only tags but also parameters of tags are checked. For example, the image tag (<IMG>) can have many parameters, but the server may filter out all but the “width” and “height” parameters. Applying the whitelist to the content improves the consistency of the content maintained by the unified editing system server. The whitelist may also remove potentially harmful content such as scripts, ActiveX controls, or other executable code. These types of elements may be contained with script tags (<SCRIPT>) or object tags (<OBJECT>) that are not in the whitelist, such that these elements are removed from the content received from the client.

In some embodiments, the unified editing system may provide a feedback mechanism through which a user can request adding additional tags to the whitelist. A whitelist may filter out some content that a user would like to use in a collaborative web page, and the feedback mechanism provides a way for users to inform the operator of the unified editing system about these types of content. For example, a new type of content may be added to the HTML specification that was not available when the whitelist was originally created. Thus, the operator of the unified editing system can add and remove entries from the whitelist as needed to allow different types of content to come through.

In some embodiments, the unified editing system performs tag-specific handling on the content received from the client. Certain tags may require additional handling that is performed by a tag-specific handling component. For example, the unified editing system may perform several special steps for anchor tags (<A>), which contain links to other web pages. First, the unified editing system may alter the target Uniform Resource Locator (URL) specified by the “href” element of the anchor tag. If the content is contained within the same website as the collaborative web page that contains the anchor, the unified editing system may remove or strip any excess information about the website from the URL, making the URL relative to the current page. For example, a link to “www.wikifido.com/mycontent” may be changed to simply “/mycontent” if it is contained within another page on the website www.wikifido.com. Next, the unified editing system may add the element “class=external” to the anchor tag to indicate to a client rendering the content that the linked resource comes from an external source. The client may use this information, for example, to open the linked resource in a new window or to warn the user that the user is leaving the website containing the link. Finally, the unified editing system may add the element “rel=nofollow” to the anchor tag to reduce the incentive for “link farming.” Link farming, sometimes called “link spam,” occurs when an operator of a spam website tries to increase their page rank with search engines by posting their link to many different collaborative websites, blogs, and so forth. Because many search engines increase a link's relevance based on the number of times the link is encountered on the Internet, spam websites have made a practice of adding their links to as many web pages as possible, which is potentially disruptive to collaborative web page users. Therefore, search engines from Google, Yahoo, and Microsoft have been modified to interpret the “rel=nofollow” element as indicating that the website operator has not vetted the content specified by the link, and therefore the search engine should not follow the link or give additional weight to the relevance of the link based on its appearance within the operator's website.

In some embodiments the unified editing system optimizes stored images specified by the image tag (<IMG>). For example, the unified editing system may receive an image from the client having a much higher resolution than the requested rendering size of the image specified in the “width” and “height” elements of the image tag. The unified editing system may store the image at the full resolution, but modify the URL referring to the image to indicate the preferred width and height. Thus, when the client requests the image using the modified URL, the server can reduce the resolution of the image to save bandwidth between the client and server, while still maintaining the full size image in case the user later wants to edit the web page to contain a larger display of the image.

In some embodiments, the unified editing system modifies references to embedded resources. Resources can be embedded in web pages using the embed tag (<EMBED>). An embedded resource can include many types of content, such as a Google Calendar, YouTube video, and so on. Embedded resources are difficult to review when they are submitted, and may contain content that is offensive, copyrighted, or otherwise illegal. In addition, laws often require that a website operator provide a mechanism for taking down offensive content. Thus, the unified editing system may modify the URL of embedded content such that references to the content are routed through the operator's web site in a manner that allows the operator to control the display of the content. For example, a reference to “www.youtube.com/myvideo” may be changed to “www.wetpaint.com/resource/1018245” where 1018245 is an identifier assigned to the external resource by the operator of the www.wetpaint.com website. When the client displays a web page containing the resource, the www.wetpaint.com website normally redirects the client to the original location of the resource. However, if a request to remove the content is received, the operator can flag that content as having been removed, and when the request is received to display the content, the server can provide alternate content such as a message that the content has been removed. Thus, the operator has the ability to control which external content is displayed within the collaborative web page.

In some embodiments, the unified editing system applies a blacklist to links and other references to external resources. For example, the unified editing system may filter external resources based on the type of resource (e.g., the file type of a file). Some files, such as VBS or REG files, may contain harmful scripts and are not typically shared among users. Thus, the unified editing system may remove references to these types of external resources. In some embodiments, the unified editing system may verify that links work and reference valid external resources.

In some embodiments, the unified editing system allows users to create content using advanced web page features such as cascading style sheets (CSS) or user-created scripts. The unified editing system may provide additional processing for normalizing content using these types of features. For example, the unified editing system may provide a whitelist applicable to CSS information or scripting commands to filter the types of content that user's can specify. For user-created scripts, the unified editing system may provide a “sandbox” in which the system can safely run the scripts to verify that the scripts are safe for running on a client of the unified editing system. In addition, the server may perform other types of processing such as running a profanity filter on the content received from the client to remove offensive language or other undesirable content.

### HTML Examples

This section provides a few examples of HTML content at various stages of its lifecycle, as reported by three different browsers: Mozilla Firefox, Microsoft Internet Explorer, and Apple Safari. The initial content is the same in each scenario and the edits made are identical: some text is bolded, some italicized, and some centered. The lifecycle stages are defined as follows:
1. Initial Content 115—This is sent from the server to the browser and is identical in all scenarios.
2. Prepped for Editing 120—This is the content after it has been rendered by the browser, and after an initial pass has been made on the content to prepare it for the common editing experience.
3. After Edits Have Been Made 125—This is the content after edits (defined above) have been made in the browser-preferred format.
4. Content Sent To Server 130—This is the content after it has been prepared for saving. Any irregularities at this point are handled by the server.

Mozilla Firefox

1. Initial Content (Standardized Markup):

Now is the time for all good men to come to the aid of
their country.<br><br>This line will be
centered.<br><table class=“wp-border-all” align=“bottom”
cellpadding=“3” width=“400”> <tbody> <tr> <td
width=“50%”><br></td> <td width=“50%”><br></td></tr>
<tr> <td width=“50%”><br></td> <td
width=“50%”><br></td></tr></tbody></table>

2. Prepped For Editing (WYSIWYG Markup)

Now is the time for all good men to come to the aid of
their country.<br><br>This line will be
centered.<br><table class=“wp-border-all” align=“bottom”
cellpadding=“3” width=“400”> <tbody> <tr> <td
width=“50%”><br></td> <td width=“50%”><br></td></tr>
<tr> <td width=“50%”><br></td> <td
width=“50%”><br></td></tr></tbody></table><br>

3. After Edits Have Been Made (WYSIWYG Markup)

Now is the time for all <i>good men</i> to <b>come to the
aid</b> of their country.<br><br><div align=“center”>This
line will be centered.<br></div><br><table class=“wp-
border-all” align=“bottom” cellpadding=“3” width=“400”>
<tbody> <tr> <td width=“50%”><br></td> <td
width=“50%”><br></td></tr> <tr> <td
width=“50%”><br></td> <td
width=“50%”><br></td></tr></tbody></table><br>

4. Content Sent To Server (Standardized Markup)

Now is the time for all <i>good men</i> to <b>come to the
aid</b> of their country.<br><br><div align=“center”>This
line will be centered.</div><br><table class=“wp-border-
all” align=“bottom” cellpadding=“3” width=“400”> <tbody>
<tr> <td width=“50%”><br></td> <td
width=“50%”><br></td></tr> <tr> <td
width=“50%”><br></td> <td
width=“50%”><br></td></tr></tbody></table><br>

Microsoft Internet Explorer

1. Initial Content (Standardized Markup):

Now is the time for all good men to come to the aid of
their country.<br><br>This line will be
centered.<br><table class=“wp-border-all” align=“bottom”
cellpadding=“3” width=“400”> <tbody> <tr> <td
width=“50%”><br></td> <td width=“50%”><br></td></tr>
<tr> <td width=“50%”><br></td> <td
width=“50%”><br></td></tr></tbody></table>

2. Prepped For Editing (WYSIWYG Markup)

<P>Now is the time for all good men to come to the aid of
their country.</P><P>&nbsp;</P><P>This line will be
centered.</P><P>&nbsp;</P><TABLE class=wp-border-all
cellPadding=3 width=400 align=bottom> <TBODY> <TR> <td
width=“50%”><P>&nbsp;</P></td> <td
width=“50%”><P>&nbsp;</P></td></TR> <TR> <td
width=“50%”><P>&nbsp;</P></td> <td
width=“50%”><P>&nbsp;</P></td></TR></TBODY></TABLE><P>&nbsp;
</P>

3. After Edits Have Been Made (WYSIWYG Markup)

<P>Now is the time for <EM>all good men</EM> to
<STRONG>come to the aid</STRONG> of their country.</P>
<P>&nbsp;</P> <P align=center>This line will be
centered.</P> <P>&nbsp;</P> <TABLE class=wp-border-all
cellPadding=3 width=400 align=bottom> <TBODY> <TR> <TD
width=“50%”> <P>&nbsp;</P></TD> <TD width=“50%”>
<P>&nbsp;</P></TD></TR> <TR> <TD width=“50%”>
<P>&nbsp;</P></TD> <TD width=“50%”>
<P>&nbsp;</P></TD></TR></TBODY></TABLE> <P>&nbsp;</P>

4. Content Sent To Server (Standardized Markup)

Now is the time for <i>all good men</i> to <b>come to the
aid</b> of their country.<br><br><div align=“center”>This
line will be centered.</div><br><TABLE class=wp-border-
all cellPadding=3 width=400 align=bottom> <TBODY> <TR>
<td width=“50%”><br></td> <td width=“50%”><br></td></TR>
<TR> <td width=“50%”><br></td> <td
width=“50%”><br></td></TR></TBODY></TABLE><br>

Apple Safari

1. Initial Content (Standardized Markup):

Now is the time for all good men to come to the aid of
their country.<br><br>This line will be
centered.<br><table class=“wp-border-all” align=“bottom”
cellpadding=“3” width=“400”> <tbody> <tr> <td
width=“50%”><br></td> <td width=“50%”><br></td></tr>
<tr> <td width=“50%”><br></td> <td
width=“50%”><br></td></tr></tbody></table>

2. Prepped For Editing (WYSIWYG Markup)

Now is the time for all good men to come to the aid of
their country.<BR><BR>This line will be
centered.<BR><TABLE align=“bottom” cellpadding=“3”
class=“wp-border-all” width=“400”> <TBODY><TR><TD
width=“50%”><BR></TD><TD
width=“50%”><BR></TD></TR><TR><TD
width=“50%”><BR></TD><TD
width=“50%”><BR></TD></TR></TBODY></TABLE>

3. After Edits Have Been Made (WYSIWYG Markup)

<SPAN class=“Apple-style-span”>Now is the time for <SPAN
class=“Apple-style-span” style=“font-style: italic;”>all
good men</SPAN> to <SPAN class=“Apple-style-span”
style=“font-weight: bold;”>come to the aid</SPAN> of
their country.<BR><BR><DIV style=“text-align:
center;”>This line will be centered.<BR> </DIV>
<BR><TABLE align=“bottom” cellpadding=“3” class=“wp-
border-all” width=“400”> <TBODY><TR><TD
width=“50%”><BR></TD><TD
width=“50%”><BR></TD></TR><TR><TD
width=“50%”><BR></TD><TD
width=“50%”><BR></TD></TR></TBODY></TABLE></SPAN>

4. Content Sent To Server (Standardized Markup)

Now is the time for <i>all good men</i> to <b>come to the
aid</b> of their country.<BR><BR><div align=“center”>This
line will be centered. </div ><BR><TABLE align=“bottom”
cellpadding=“3” class=“wp-border-all” width=“400”>
<TBODY><TR><td width=“50%”><BR><br></td><td
width=“50%”><BR><br></td></TR><TR><td
width=“50%”><BR><br></td><td
width=“50%”><BR><br></td></TR></TBODY></TABLE>

### CONCLUSION

From the foregoing, it will be appreciated that specific embodiments of the unified editing system have been described herein for purposes of illustration, but that various modifications may be made without deviating from the spirit and scope of the invention. For example, although HTML has been primarily described, other languages for specifying collaborative content also work well with the system. Languages such as XML, RDF (often used for social networking), and RTF each can be used to provided collaborative content that can be translated using the methods described above. The techniques described can also be used with many additional platforms, such as Binary Run-time Environment for Wireless (BREW), Java 2 Micro Edition (J2ME), and Java 2. Accordingly, the invention is not limited except as by the appended claims.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/we claim:

1. A method in a computer system for editing a wiki among two or more different browsers, the method comprising:
at a first time, receiving from a first browser a request to edit content of a wiki;
receiving the content of the wiki in a normalized format, wherein the normalized format is independent of a browser format;
translating the content from the normalized form to a first browser format of the first browser;
receiving edited content in the first browser format, wherein the edited content includes one or more changes to the content of the wiki;
translating the edited content from the first browser format to the normalized format;
storing the edited content in the normalized format;
at a second time subsequent to the first time, receiving from a second browser a request to edit the edited content, wherein the second browser is different from the first browser;
receiving the edited content in the normalized format;
translating the content from the normalized format to a second browser format of the second browser, wherein the second browser format is different from the first browser format;
receiving a second edited content in the second browser format, wherein the second edited content includes one or more changes to the edited content;
translating the second edited content from the second format to the normalized format; and
storing the second edited content in the normalized format such that the second edited content can be edited independent of any browser format.

2. The method of claim 1 further comprising displaying the content of the wiki in the first browser format; and
in response to receiving an edit command from a user, translating the content from the first browser format to a What You See Is What You Get (WYSIWYG) format.

3. The method of claim 1 wherein at least one piece of the content is a video or an image.

4. The method of claim 3 further comprising replacing the at least one piece of content with a placeholder, wherein at least one attribute of the placeholder is editable.

5. The method of claim 4 wherein the at least one attribute corresponds to the size of the placeholder.

6. The method of claim 4 wherein the at least one attribute corresponds to the position of the placeholder.

7. The method of claim 1 wherein the content of the wiki comprises one or more content types selected from the group comprising: plain text, formatted text, graphic, video, sound, calendar, map, slideshow, or link to external content.

8. A tangible computer-readable storage medium encoded with instructions that, when executed by a computer, cause the computer to perform a method for editing a web page, the method comprising:
receiving from a user a request to edit a web page;
receiving the web page in a normalized form, wherein the normalized form is independent of any browser form;
displaying to the user the web page, wherein the web page has been translated from the normalized form to a browser-dependent form, and wherein the web page in browser-dependent form is editable by the user; and
receiving from the user an edited web page in the browser-dependent form, wherein the edited web page includes one or more changes to the web page.

9. The computer-readable storage medium of claim 8 wherein the method further comprises: determining a display size of the computer; and
modifying the web page in browser-dependent form relative to the display size such that the web page is displayed to the user based on the display size of the computer.

10. The computer-readable storage medium of claim 8 wherein the method further comprises: determining a type of the web page; and
when the determined type indicates that the web page is new, providing to the user one or more templates for creating a collaborative web page.

11. The computer-readable storage medium of claim 8 wherein the method further comprises: determining a preferred language of the user; and
when the preferred language of the user is different from a language of the web page, translating the language of the web page to the preferred language of the user.

12. A system for editing a collaborative web page using a first browser and a second browser, wherein the first browser is different from the second browser, the system comprising,
an edit request component configured to receive a request to edit a collaborative web page, wherein the collaborative web page includes at least one tag;
a convert component configured to convert the collaborative web page from a standardized format to a preferred-browser format when the standardized format is different from the preferred-browser format;
a receive edits component configured to receive edits to the collaborative web page in the preferred-browser format and convert the collaborative web page from the browser-preferred format to the standardized format when the browser-preferred format is different from the standardized format;
a store component configured to store the collaborative web page and any received edits to the collaborative web page in the standardized format,
wherein the standardized format the same as the preferred-browser format of the first browser.

13. The system of claim 12 further comprising a whitelist component configured to:
compare one or more whitelist tags to the at least one tag of the collaborative web page; and
when a whitelist tag is the same as the at least one tag of the collaborative web page, convert the at least one tag of the collaborative web page to the whitelist tag.

14. The system of claim 12 further comprising a blacklist component configured to:
compare one or more blacklist file types to a file type of at least one piece of content of the collaborative web page; and
when a blacklist file type is the same the file type of the at least one piece of content of the collaborative web page, remove the at least one piece of content from the collaborative web page.

15. The system of claim 12 further comprising an analysis component configured to:
determine whether the at least one tag is necessary to render the collaborative web page; and
when the at least one tag is not necessary to render the collaborative web page, remove the at least one tag.

16. The system of claim 15 wherein the analysis component is further configured to:
when the at least one tag is necessary to render the collaborative web page, determine whether one or more attributes of the at least on tag are necessary to render the collaborative web page; and
for each of the one or more attributes that are not necessary to render the collaborative web page, remove the attribute.

17. The system of claim 12 further comprising a verify component configured to:
when the at least one tag of the collaborative web page includes a URL, verify the URL.

18. The system of claim 12 further comprising a sandbox component configured to:
when the edits to the collaborative web page include at least one script, execute the script to verify that the script is safe to run on a computer.
